(19) United States
(12) Patent Application Publication
(10) Pub. No.: US 2018/0225327 A1
(43) Pub. Date: Aug. 9, 2018

(54) DATA FLOW PROCESSING METHOD

(71) Applicant: INTELIE SOLUÇÕES EM INFORMÁTICA LTDA., Rio de Janeiro (BR)

(72) Inventors: Ricardo Gomes Clemente, Rio de Janeiro (BR); Hubert Aureo Cerqueira Lima Da Fonseca, Rio de Janeiro (BR); Juan Pedro Alves Lopes, Rio de Janeiro (BR)

(21) Appl. No.: 15/498,863

(22) Filed: Apr. 27, 2017

(30) Foreign Application Priority Data
Feb. 3, 2017 (BR) 10-2017-002327-3

(51) Int. Cl. G06F 17/30

(52) U.S. Cl. CPC G06F 17/30463; G06F 17/30474

(57) ABSTRACT

The present invention describes a method capable of interpreting user-defined queries, translating them into a model of automata for data flow processing, planning the distribution of the computing between the nodes of a distributed system, identifying computations with high potential of memory consumption and, when identified, allocating appropriate data structures for each computation, allocating the amount of memory required to meet the specified error margin, distributing the computation between the active nodes of a distributed system, and synchronizing the partial results at each defined moment and releasing the final result.

### TECHNICAL FIELD

This invention relates to the field of the real-time data flow processing.

The present invention describes a method capable of interpreting user-defined queries, translating them into a model of automata for data flow processing, planning the distribution of the computing between the nodes of a distributed system, identifying computations with high potential of memory consumption, allocating appropriate data structures for each computation, allocating the minimum amount of memory required to meet the specified error margin, distributing the computation between the active nodes of a distributed system, and synchronizing the partial results at each defined moment and releasing the final result.

### BACKGROUND OF THE INVENTION

Because of the popularity of the mobile devices as well as the fall in storage costs in digital media that make them more affordable, the amount of data generated around the world has increased exponentially.

Even with the well-known popularity of the mobile devices, a number of other large data generators can be cited, such as intelligent sensors that pick-up information about some particular environment and are able to make some kind of decision based on the input data or operations on the financial market, where formulas and mathematical algorithms are used to define which asset can best fit the proposed model, detecting several necessary variables and moving as expected. Also, we can cite measurements of computer networks, telephone records, visited webpages, among many others.

In view of the large amount of data generated by the most varied sources, methods for a better processing thereof are necessary.

The use of the real-time data analysis is quite prominent for operations that require agility, autonomy, innovation, as well as care with the information. The need to obtain information from large amounts of data that are generated at high speed requires adequate computational strategies.

A real-time data analysis platform has the capacity to identify patterns in the operations in relation to certain factors, such as, for example, the waiting time in a transaction, number of buyers of a particular product, as well as alerting about an anomaly to be corrected as soon as possible.

This real-time data analysis allows, for example, a better understanding of the user interaction, identification of opportunities, as well as the understanding of the behavior of the operation in real-time, guaranteeing an immediate improvement. In addition, it is possible to monitor and correct deviations in the operational processes, predict unwanted situations, thus increasing the safety of the operation.

### STATE OF THE ART

US 20110314019 describes a data flow processing method, wherein the query mechanism occurs through splitting into subquery, which is performed on at least one node. The configuration of each node, wherein a subquery is executed, comprises periodically receiving CPU and memory usage data on each node of all nodes on which the query is being performed. Also, a comparison of the usage data through the nodes occurs, and if the comparison exceeds a predefined threshold, the node reconfigures the data partition, as well as selects free nodes to receive the load from other nodes.

WO 2013153027 discloses a continuous data flow processing system, wherein the nodes of the distributed system are configured to perform functions of reduce, and produce a state in the local memory of said node. Said system performs the data processing through a data queue, which is performed automatically when there is no available input data on the respective node and, in the form of queue data, uses said output states of each node, as inputs for the operations of reduce to be performed by the subsequent nodes. The nodes of this system comprise a local disk and local memory for storage and/or retrieval.

### SUMMARY OF THE INVENTION

The present invention describes a method capable of (i) interpreting user-defined queries, (ii) translating them into a model of automata for data flow processing, (iii) planning the distribution of the computation between the nodes of the distributed system (cluster), (iv) identifying computations with high potential of memory consumption and, when identified, (v) allocating appropriate data structures for each computation, (vi) allocating the amount of memory required to maintain the configured error margin, (vii) distributing the computation between the active nodes of a distributed system, (viii) synchronizing the partial results at each defined moment and (ix) releasing the final result.

The method described here represents a change from conventional methods as it identifies operations with high potential of memory consumption and applies probabilistic data structures to keep the memory consumption reduced and controlled.

### BRIEF DESCRIPTION OF THE FIGURES

The invention may be better understood through the brief description of the following drawings:

FIG. 1 represents an illustrative diagram of the method for distributed data flow processing with memory consumption optimization.

FIG. 2 represents an illustrative diagram of the computation distribution between nodes of the distributed system and the use of probabilistic structures to optimize the memory consumption.

### DETAILED DESCRIPTION OF THE INVENTION

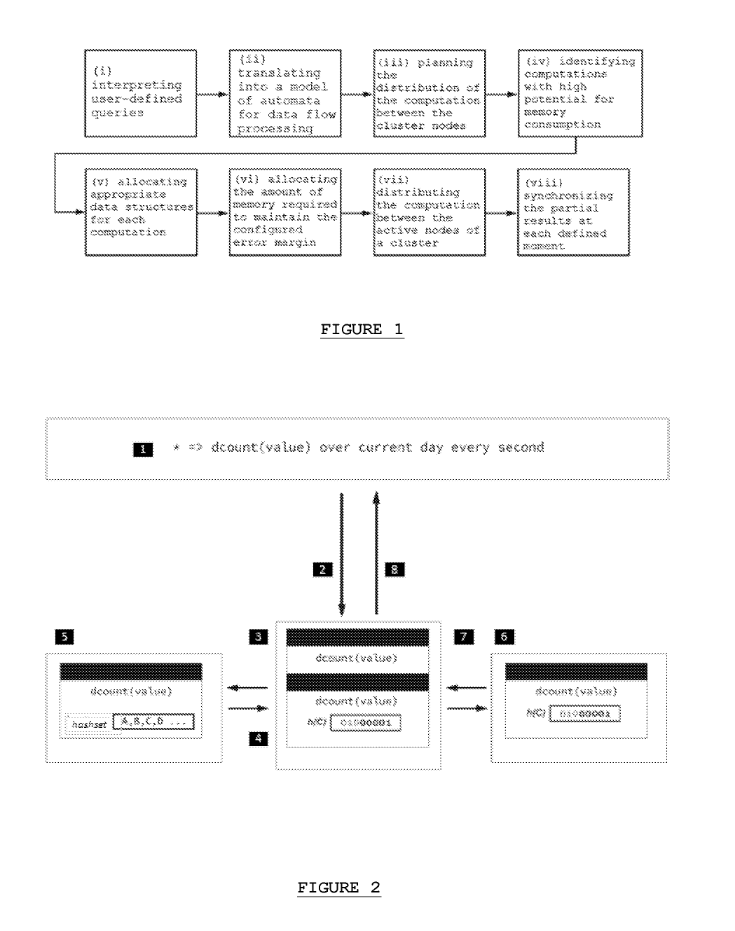

The present invention describes, as shown in FIG. 1, a method capable of: (i) interpreting user-defined queries, that is, respecting the syntax of a language specifically created for the expression of logical and temporal conditions, the user can freely write queries that will be interpreted for processing, (ii) translating them into a model of automata for data flow processing, (iii) planning the distribution of the computation between the nodes of the distributed system, that is, creating the execution plan of operations on each node, as well as the definition of the node that will be responsible for the synchronization and obtainment of results, (iv) identifying computations with high potential of memory consumption and, when identified, (v) allocating appropriate data structures for each computation (vi) allocating the amount of memory required to maintain the error margin configured, (vii) distributing the computation between the active nodes of a distributed system, that is, allocating to each node the processing that needs to be performed locally, (viii) synchronizing the partial results at each defined moment and (ix) releasing the final result, that is, sending the result obtained at each moment defined for the output of the method, so that it can be consumed and used in the practice.

In the said method, for a better identification of computations with high potential of memory consumption, three mathematical operations which are mapped to treatment have been defined. These are: the single element counting, the percentile calculation, and the median calculation.

For each node of said method that is involved in the distributed data processing, one of these three operations is assigned and must activate its control mechanism.

A node of said system may perform one or more operations of any type, at any time, according to the query or the expressions performed by the user.

The query performed by the user can generate one or more calculations of any type to be executed by the nodes of said system.

If in a node in said method, the number of elements in the managed set is above of a predetermined threshold, for example, around 1000 (one thousand) elements, said node must abandon the traditional method and activate a probabilistic data structure.

For the single element counting operation, the probabilistic data structures HyperLogLog and Hashset are used. On the other hand, the structure Count-min Sketch is used for the percentile calculation and the median calculation.

At each of the mathematical operations described previously, with high potential of memory consumption, a relevant probabilistic data structure is assigned.

The definitions of the probabilistic data structures HyperLogLog, Hashset, and Count-min Sketch are described below:

The HyperLogLog is an algorithm created to solve the problem of distinct counting of elements. Its role is to be able to probabilistically estimate the cardinality of elements in a multi-set. For this, the use of a function that encodes the original elements in evenly distributed random numbers is done. Using the size of the largest binary prefix composed entirely of zeros among all observed numbers, it is possible to estimate the amount of distinct elements.

The probabilistic data structure Hashset, on the other hand, increases the performance without compromising the correction of the final result of the operation, whereas the probabilistic data structure HyperLogLog also increases the performance, while accepting a controlled degree of error.

The Count-min Sketch is a probabilistic data structure that is able to calculate the frequency of the elements in a multi-set. Functions that encode original elements in columns of a matrix are used. When a same element is coded again, the increment in the cells of the matrix in which it impacts is performed. Using this mechanism, it is possible to estimate the frequency of the elements in the multi-set.

A error margin is previously configured for said method and for that error margin to be tolerated, said method will allocate the minimum of possible memory space for each data structure.

In the present method described here, illustrated by FIG. 2, a query is created by the end user and makes use of the function dcount—counting of distinct elements—which has potential of high memory consumption (1). The query is interpreted and sent to one of the nodes of the distributed system (2). This node will distribute the computation among all the active nodes in the distributed system, being also responsible for the synchronization of the results (3) and, in addition, the node itself also assumes part of the computation (4). In this case, because it has more than one thousand elements in the set, a data structure is used—HyperLogLog—for the computation.

When the node has no more than one thousand elements being processed, it maintains a structure of unique elements list—Hashset (5), wherein the third active node in the distributed system also receives the same computation, and, also because it has more of one thousand elements being computed, makes use of the structure of HyperLogLog (6).

Within the specified period, in the case, every second, all nodes respond with partial results to the node responsible for the synchronization—the master node. This node makes the combination of the individual results of each node (7).

By synchronizing and consolidating the results of each node at each defined instant, said method is able to identify if any node made use of some probabilistic data structure.

If any node used a probabilistic approach to the calculation of results, the method transforms the calculations of all nodes, even those that have not used any probabilistic data structure. This process is necessary for the results consolidation be performed, and, then, transferred back to the user (8).

The present invention has been disclosed in this specification in terms of its preferred embodiment. However, other modifications and variations are possible from the present description, and are still within the scope of the invention disclosed herein.

1. A data flow processing method comprising the steps of:
(i) interpreting user-defined queries;
(ii) translating said interpreted user-defined queries into a model of automata for data flow processing;
(iii) planning a distribution of a computation between nodes of a distributed system;
(iv) identifying the computations with high potential of memory consumption, and when identified,
(v) allocating data structures for each computation;
(vi) allocating an amount of memory required to maintain a configured error margin;
(vii) distributing the computation between active nodes of the distributed system; and
(viii) synchronizing partial results at defined moments.

2. The processing method according to claim 1, wherein the step of identifying the computations with high potential of memory consumption is performed at each node by one of: the single element counting operation, the percentile calculation operation, and the median calculation operation.

3. The processing method according to claim 2, CHARACTERIZED in wherein the nodes that perform the single elements counting operation use the probabilistic data structures HyperLogLog and Hashset.

4. The processing method according to claim 3, wherein the data structure HyperLogLog is used if an amount of elements is more than one thousand elements.

5. The processing method according to any one of claim 3, wherein the data structure Hashset is used if an amount of elements is less than one thousand elements.

6. The processing method according to claim 2, wherein the nodes that perform the operation of percentile calculation and median calculation use the probabilistic data structure Count-min Sketch.

7. The processing method according to claim 1, wherein the system allocates the minimum memory space required for each of the data structures.

8. The processing method according to claim 1, wherein the operation of counting distinct elements, having potential of high memory consumption (1), is interpreted and sent to one of the nodes of the distributed system (2); wherein said one of the nodes distributes the computation among all active nodes in the distributed system, synchronizing the results (3) and assuming part of the computation (4); wherein the data structures maintain a unique elements list structure (5), a third active node in the distributed system also receives the same computation and also makes use of the element counting structure (6) within a specified period of time, wherein all nodes respond with partial results to the node responsible for the synchronization, combining the individual results of each node (7) and synchronizing and consolidating the results of each node at each defined instant, identifying a possibility of using structures of probabilistic data for the calculation of results using the node, transforming the calculations of all the nodes, to consolidate the results and transfer back said consolidated results to the user (8).
